(19) United States
(12) Patent Application Publication
(10) Pub. No.: US 2014/0361692 A1
(43) Pub. Date: Dec. 11, 2014

(54) ADJUSTABLE THREE-STAGE LIGHT EMITTING DIODE BULB

(71) Applicants: TAI-HSIANG HUANG, TAINAN CITY (TW); KUAN-HSIANG HUANG, TAINAN CITY (TW)

(72) Inventors: TAI-HSIANG HUANG, TAINAN CITY (TW); KUAN-HSIANG HUANG, TAINAN CITY (TW)

(21) Appl. No.: 13/912,480

(22) Filed: Jun. 7, 2013

(51) Int. Cl. H05B 33/08

(52) U.S. Cl. CPC H05B 33/0845
USPC 315/127; 315/201

(57) ABSTRACT

A three-stage power adjustable Light Emitting Diode bulb includes a first resistance and a second resistance which is electrically connected to the first resistance in parallel. The first resistance and the second resistance are connected to a rectifier. Multiple Light Emitting Diode units and a limiting resistance are connected between the positive and negative poles of the rectifier. The Light Emitting Diode units each have multiple Light Emitting Diodes. The electric energy consumption of the Light Emitting Diode bulb is reduced and the life of use of the Light Emitting Diode bulb is prolonged. The resistance value of the first and second resistance can be adjusted to have different luminous powers.

### BACKGROUND OF THE INVENTION

1. Fields of the Invention

The present invention relates to a Light Emitting Diode bulb (LED bulb), and more particularly, to a three-stage power adjustable Light Emitting Diode bulb with adjustable resistances to have different output power.

2. Descriptions of Related Art

The conventional three-stage adjustable bulb 31 comprises a first Tungsten-filament 311 of lower power and a second Tungsten-filament 312 of high power located in the bulb 31. The circuit for the conventional three-stage adjustable bulb 31 is disclosed in FIG. 5. A three-stage switch 32 is cooperated with the three-stage adjustable bulb 31. The first switch of the three-stage switch 32 is connected to the first Tungsten-filament 311 and the second switch of the three-stage switch 32 is connected to the second Tungsten-filament 312. The third switch of the three-stage switch 32 is connected to the first and second Tungsten-filaments 311, 312 in parallel. When the users switch to the first switch of the three-stage switch 32, the first Tungsten-filament 311 of lower power is activated. When the users switch to the second switch of the three-stage switch 32, the second Tungsten-filament 312 of lower power is activated. When the users switch to the third switch of the three-stage switch 32, the first and second Tungsten-filaments 311, 312 are both activated to have the maximum output power.

However, the Tungsten-filaments consume significant electric power energy and have shorter life. The conventional three-stage adjustable bulb using Tungsten-filaments cannot change their luminous power according to practical needs.

The present invention intends to provide a three-stage power adjustable Light Emitting Diode bulb which has adjustable resistances to have different output power.

### SUMMARY OF THE INVENTION

The present invention relates to a three-stage power adjustable Light Emitting Diode bulb and comprises a first resistance and a second resistance which is electrically connected to the first resistance in parallel. The first resistance and the second resistance are connected to a rectifier. Multiple Light Emitting Diode units and a limiting resistance are connected between the positive and negative poles of the rectifier. The Light Emitting Diode units each have multiple Light Emitting Diodes.

Preferably, a fuse is connected between the first and second resistances and the rectifier.

The primary object of the present invention is to provide a three-stage power adjustable Light Emitting Diode bulb wherein the electric energy consumption of the Light Emitting Diode bulb is reduced and the life of use of the Light Emitting Diode bulb is prolonged. The resistance value of the first and second resistance can be adjusted to have different luminous powers.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the circuit of the three-stage power adjustable Light Emitting Diode bulb of the present invention;

FIG. 2 shows the circuit of the first way of use of the three-stage power adjustable Light Emitting Diode bulb of the present invention;

FIG. 3 shows the circuit of the second way of use of the three-stage power adjustable Light Emitting Diode bulb of the present invention;

FIG. 4 shows the circuit of the third way of use of the three-stage power adjustable Light Emitting Diode bulb of the present invention, and

FIG. 5 shows the circuit of the conventional three-stage adjustable bulb.

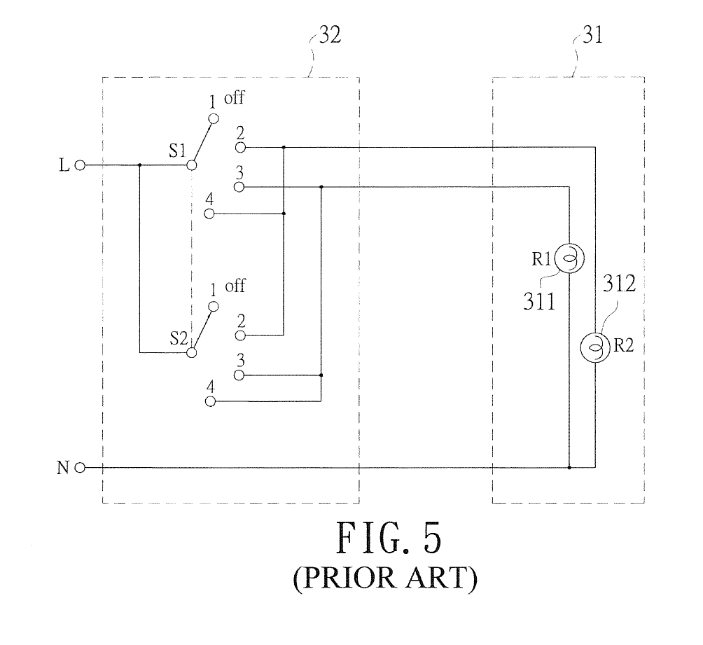

### DETAILED DESCRIPTION OF THE PREFERRED EMBODIMENT

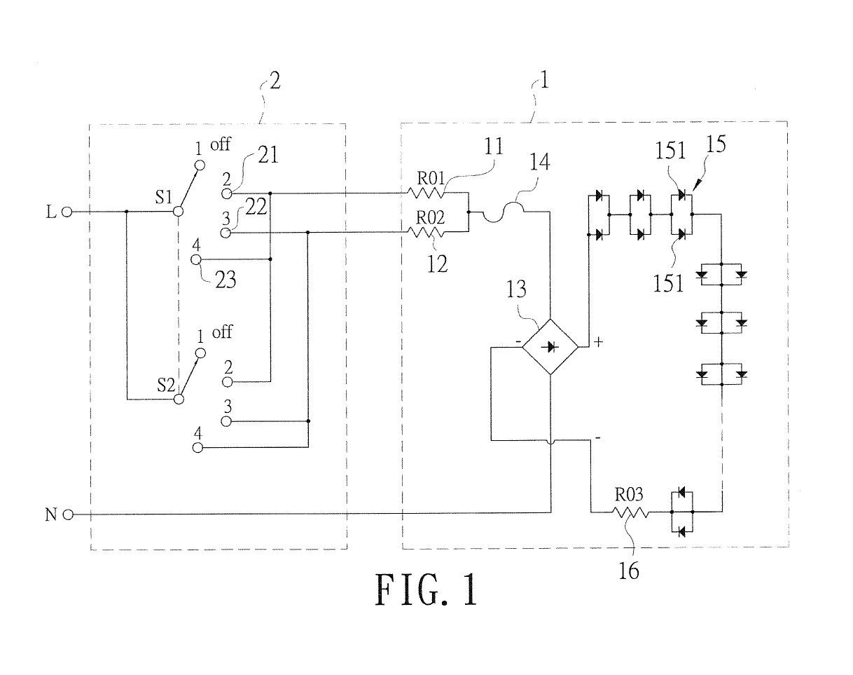

Referring to FIG. 1, a three-stage power adjustable Light Emitting Diode bulb 1 of the present invention is cooperated with a three-stage switch 2 and comprises a first resistance 11 and a second resistance 12 which is electrically connected to the first resistance 11 in parallel. The first resistance 11 and the second resistance 12 are connected to a rectifier 13. A fuse 14 is connected between the first and second resistances 11, 12 and the rectifier 13. Multiple Light Emitting Diode units 15 and a limiting resistance 16 are connected between positive and negative poles of the rectifier 13. The Light Emitting Diode units 15 each have multiple Light Emitting Diodes 151.

A first switch 21 of the three-stage switch 2 is connected to the first resistance 11 of the three-stage power adjustable Light Emitting Diode bulb 1. A second switch 22 of the three-stage switch 2 is connected to the second resistance 12 of the three-stage power adjustable Light Emitting Diode bulb 1. A third switch 23 of the three-stage switch 2 is connected to both of the first and second resistances 11, 12 of the three-stage power adjustable Light Emitting Diode bulb 1.

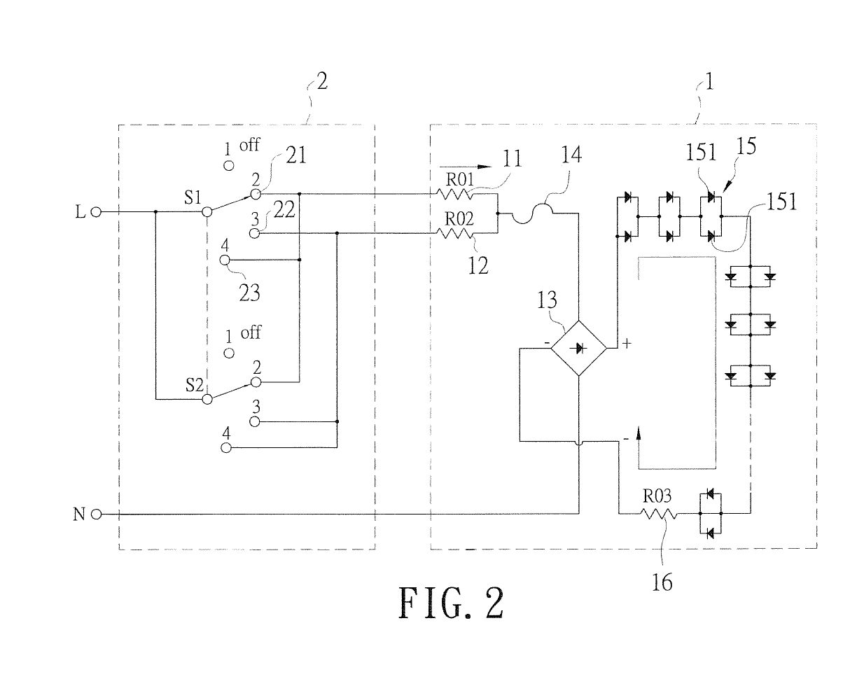

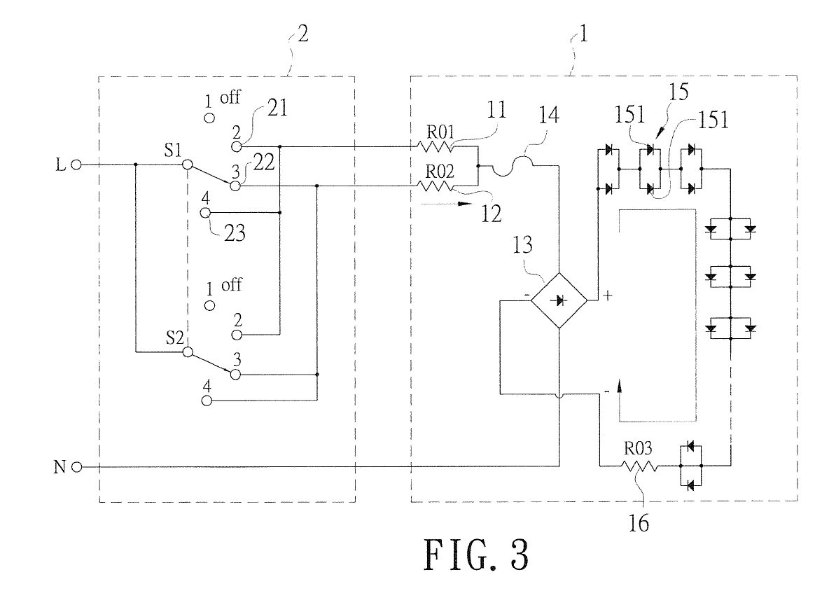

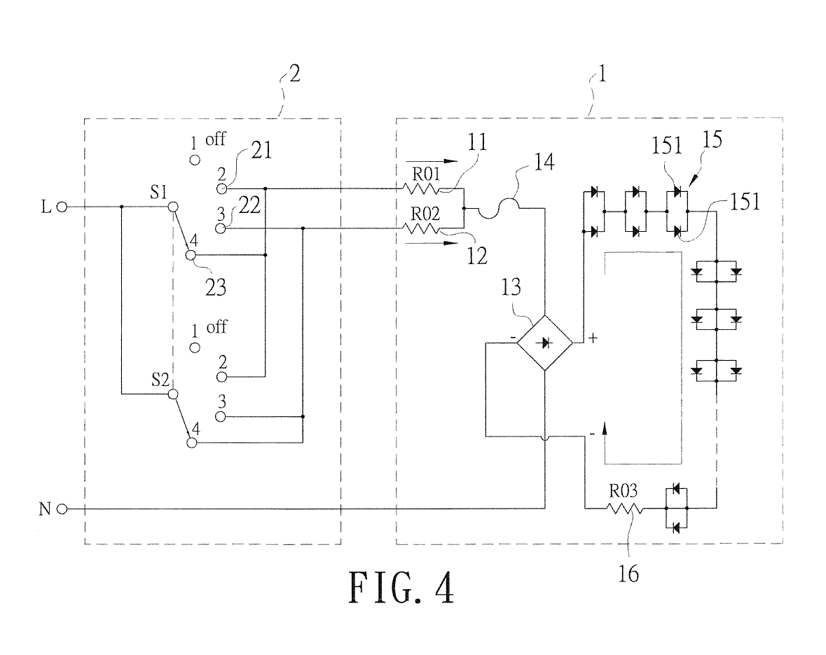

When the user switches to the first switch 21, as shown in FIG. 2, the current passes through the first resistance 11 of the three-stage power adjustable Light Emitting Diode bulb 1, and is rectified by the rectifier 13 so as to provide proper power to the Light Emitting Diodes 151 of the Light Emitting Diode units 15. As shown in FIG. 3, when the user switches to the second switch 22, the current passes through the second resistance 12 of the three-stage power adjustable Light Emitting Diode bulb 1, and is rectified by the rectifier 13 so as to provide proper power to the Light Emitting Diodes 151 of the Light Emitting Diode units 15. Because the first and second resistances 11, 12 have different resistance values, so that the voltages provided to the rectifier 13 are different, so that the Light Emitting Diodes 151 of the Light Emitting Diode units 15 provides different illuminations when the second or third switch 22, 23 is set. As shown in FIG. 4, when the user switches to the third switch 23, because the second resistance 12 is electrically connected to the first resistance 11 in parallel, the current passes through the first and second resistances 11, 12 and reduce the resistance value. The current is then rectified by the rectifier 13 so as to provide proper power to the Light Emitting Diodes 151 of the Light Emitting Diode units 15. In this status, the three-stage power adjustable Light Emitting Diode bulb 1 has the maximum illumination feature. It is noted that the resistance values of the first or second resistance 11, 12 can be adjusted according to the needs of the market or consumers to provide the three-stage power adjustable Light Emitting Diode bulb 1 with proper illumination.

The three-stage power adjustable Light Emitting Diode bulb 1 optionally activates the Light Emitting Diodes 151 of the Light Emitting Diode units 15 by operation to the three-stage switch 2 so as to save energy and prolong the life of use.

While we have shown and described the embodiment in accordance with the present invention, it should be clear to those skilled in the art that further embodiments may be made without departing from the scope of the present invention.

What is claimed is:

1. A three-stage power adjustable Light Emitting Diode bulb, comprising:
a first resistance and a second resistance which is electrically connected to the first resistance in parallel, the first resistance and the second resistance being connected to a rectifier, and
multiple Light Emitting Diode units and a limiting resistance connected between positive and negative poles of the rectifier, the Light Emitting Diode units each having multiple Light Emitting Diodes.

2. The bulb as claimed in claim 1, wherein a fuse is connected between the first and second resistances and the rectifier.
